(19) United States
(12) Patent Application Publication
(10) Pub. No.: US 2013/0301416 A1
(43) Pub. Date: Nov. 14, 2013

(54) MULTI-LEVEL BEARER PROFILING IN TRANSPORT NETWORKS

(71) Applicant: Telefonaktiebolaget L M Ericsson (publ), Stockholm (SE)

(72) Inventors: Sándor Rácz, Cegled (HU); Balázs Peter Gerö, Budapest (HU); János Harmatos, Budapest (HU); Szilveszter Nádas, Budapest (HU)

(73) Assignee: Telefonaktiebolaget L M Ericsson (publ), Stockholm (SE)

(21) Appl. No.: 13/888,741

(22) Filed: May 7, 2013

(30) Foreign Application Priority Data
May 8, 2012 (EP) 12167141.6

(51) Int. Cl. H04W 28/02

(52) U.S. Cl. CPC H04W 28/0268
USPC 370/235

(57) ABSTRACT

A method is provided for transporting data packets over a telecommunications transport network. The data packets are carried by a plurality of bearers, the bearers each carrying data packets that relate to different ones of a plurality of services. In the method a multi-level bandwidth profiling scheme is applied to the data packets of each bearer. A series of information rates are assigned to a bearer, the profiling scheme identifying and marking each data packet of the bearer based on a desired resource sharing according to the minimum information rate with which the packet is conformant. The marked data packets are forwarded for transport through the transport network. If there is insufficient bandwidth available in the transport network to transport all data packets, data packets identified by the profiling and marked as only being conformant with a higher information rate are discarded before any data packets marked as being conformant with a lower information rate.

The embodiments disclosed herein relate to improvements in the handling of data communications transmitted across a transport network.

### BACKGROUND

A transport network (TN) is used to carry data signals between a Radio Base Station (RBS), such as a NodeB or an eNodeB in 3G Long-Term Evolution (LTE) networks, and a Radio Access Network (RAN) entity, such as a Radio Network Controller (RNC), Serving gateway (S-GW), or Packet Data Network gateway (PDN-GW). A TN may be operated by a mobile network operator or by a third party transport provider. In the latter case there would be a Service Level Agreement (SLA) between the mobile and transport operators. With the rapid growth of digital data telecommunications following the introduction of 3G and 4G technology, TNs may frequently act as bottlenecks in the overall data transport process. Thus, various systems and methods have been proposed for improving or prioritizing the way that data packets are transported by the bearers.

Service differentiation in the RAN is one supplementary means for more efficiently handling high volumes of traffic. As a simple example, when using service differentiation a higher bandwidth share can be provided for a premium service, and in this way the overall system performance can be improved. As another example, a heavy service such as point-to-point traffic, can be down-prioritized. Implementing such service differentiation methods requires integration into the Quality of Service (QoS) concept of LTE and Universal Mobile Telecommunications System (UMTS) technology. Details of the QoS concept for LTE can be found in the 3^{rd} Generation Project Partnership (3GPP) Technical Specification TS 23.410. The main idea of this concept is that services with different requirements use different bearers. When a User Equipment (UE) attaches to the network a default-bearer is established (typically a best-effort service). However, if the UE invokes services having different QoS parameters, then a dedicated bearer is established for each service.

The Metro Ethernet Forum (MEF), in MEF 23, Carrier Ethernet Class of Service-Phase 1, set out a way of indicating which service frames (or data packets) are deemed to be within or outside of a Service Level Agreement (SLA) contract by assigning colors to the data packets according to the bandwidth profile. See, for example, “Bandwidth Profiles for Ethernet Services” by Ralph Santitoro, the Metro Ethernet Forum, v1.4, http://metroethernetforum.org/PDF Documents/Bandwidth-Profiles-for-Ethernet-Services.pdf. The coloring concept operates at the Class of Service (CoS) level. Identification of color can be used to indicate which service frames of a CoS are deemed to be within or outside of the contract according to the bandwidth profile. Levels of compliance are green when fully compliant, yellow when sufficiently compliance for transmission but without performance objectives, and red or discarded when not compliant with either. Note that there is no technical significance to the color itself. Instead, the color is just used as a convenient way of describing and/or labeling the data packets. The data packets of a bearer are checked against the compliance requirements by a bandwidth profiler, for example a two-rate, three-color marker.

This Ethernet validation process can be used between two parties (e.g. between two operators) and can be part of the SLA. In general, in the different SLA requirements are set for green packets and yellow packets. The green packets are “more important” than the yellow packets. To reflect this difference between the two types of packets, at a bottleneck point, such as on entry to a TN, a color aware active queue management discards yellow packets in preference to green packets when there is congestion (e.g., insufficient bandwidth available in the TN to transport all data packets).

IEEE 802.1ad introduced the Drop Eligibility (DEI) bit in Virtual Local Area Network (VLAN) tagged Ethernet frames. The DEI bit, which is mandatory in service

VLAN tagged frames but optional for customer VLAN tagged frames, is one option to mark packets as green or yellow. Another option is to use the Differentiated Services Control Point (DSCP) field in the IP header.

As indicated above, the Ethernet coloring concept described by MEF operates at the Class of Service (CoS) level, not at the bearer level. FIG. 1 illustrates the difference between the CoS level and the bearer level. In the RAN nodes (e.g., RNC) bearer level traffic handling is possible (i.e., data packets of one bearer can be treated independently of those of another bearer), whereas in the Mobile Backhaul (MBH) nodes of a TN, CoS level handling is used (i.e., the data packets can only be differentiated by their CoS), and the MBH cannot differentiate traffic at the bearer level.

There is no common solution to provide efficient Radio Bearer (RB) level service differentiation over a Transport Network bottleneck. In International patent application No. PCT/EP2011/068023, the present inventors describe a mechanism for a per-bearer level service differentiation, that makes the bandwidth sharing among RBs more RAN-controlled. This is described further below in relation to FIG. 2. The disclosed mechanism employs “color” profiling at the bearer level. Thus, for each RB, a predefined profiling rate (e.g., green rate) is assigned based on the Quality QoS Class Identifier (QCI) of the RB. This mechanism allows, to a certain degree, bandwidth guarantees to be provided for the RBs.

An alternative way to differentiate between bearers having different priorities is to use different DSCP drop precedence parameters, together with different Random Early Discard (RED) parameters, for different bearer DSCP levels. However this method, which is built on Transmission Control Protocol (TCP) congestion control, cannot provide throughput guarantees or resource sharing in a general case (e.g., in the case of a different number of TCP flows per user or different TCP versions).

FIG. 2 shows a schematic illustration of a TN employing bandwidth profiling for each of two bearers. The example is shown for an LTE system with two bearers 202, 204 each carrying data packets between a PDN-GW 206 and an eNodeB 208 via a S-GW 210 and through a TN 212. The bearers 202, 204 are designated S5/S8 bearers 202a, 204a between the PDN-GW 206 and the S-GW 210, S1 bearers 202b, 204b from the S-GW 210 over the TN 212, and radio bearers 202c, 204c beyond the eNodeB 208. Each bearer is assigned a bandwidth profiler—profiler 214 for bearer 202 and profiler 216 for bearer 204. Each of the bearers has an assigned QCI and an associated predefined Committed Information rate (CIR) or ‘green’ rate and profiler queue size. Packets of each bearer 202, 204 that conform with the bearer's profiler 214, 216 are marked as conformant packets 218 (e.g., assigned a ‘green’ color), and packets that do not conform are marked as non-conformant packets 220 (e.g., assigned ‘yellow’ color). All data packets that are not colored ‘green’ by the profilers 214, 216 are assigned ‘yellow’. For example, assume that the ‘green rate’ is 5 Mbps for a bearer, and the bitrate of this bearer is 7.5 Mbps. In this case, approximately ⅓ of the packets of this bearer will be assigned to ‘yellow’.

The TN 212 bottleneck active queue management can then use the color information marked in the data packets when choosing which packets to drop when there is insufficient bandwidth (congestion). The first packets to be dropped will be the ‘yellow’ packets 220.

In the example described, a two-color (green-yellow) profiler is used for each bearer. When the profiler 214, 216 assigns either ‘green’ or ‘yellow’ to a packet, this means that the packet is marked with the conformance information in such a way it can be used at the TN bottleneck buffer(s). For example, the Drop Eligibility (DEI) bit of the packet's Ethernet frame, or the Differentiated Services Control Point (DSCP) field in the IP header could be used to indicate if a packet has been assigned ‘green’ or ‘yellow’.

This coloring concept can also be used for improving per-service or per-bearer fairness at a bottleneck, as described in PCT/EP2011/068023. In this case, the coloring concept is used in a different way, for a different purpose and at a different location (e.g., it is done in the RAN instead of in the Mobile Backhaul (MBH) node). A green rate is assigned for a bearer (e.g., for a service of a user, and roughly speaking, a desired bitrate for that service) and data packets of the bearer that do not exceed this bitrate are colored green, whereas data packets above the green rate are colored yellow. In this case, when a bearer has yellow packets that means that it has a higher bandwidth than the desired value (but gains from this higher bandwidth when the data packets are transported through the bottleneck), so the drop of these yellow packets probably does not have a serious negative impact on the service performance. Note that in PCT/EP2011/068023, the mechanism described by the present inventors optionally includes the use of an EIR or yellow rate, wherein the profiler immediately discards data packets that do not comply with the EIR. The TN bottleneck active queue management (AQM) thus only receives green or yellow packets.

In the mechanism of FIG. 2 described above, a static profiling method is used that allows the RAN more control over the bandwidth sharing among bearers. A predefined profiling rate (e.g., green rate) is assigned to a bearer based on the QCI of the RB, and a color aware dropping of data packets is used at the TN. In this way, to a limited extent, bandwidth guarantees can be provided for the bearers and without the need for any information about the number of ongoing bearers or bottleneck capacity changes.

This static green rate setting can be used for a bearer (e.g., service) where the bandwidth requirement is known in advance—for example a streaming service. However, a relative service differentiation can be useful. For example to differentiate between a premium and a normal Internet access, then a premium user may get, e.g., four times more bandwidth than a normal user. In a High-Speed Downlink Packet Access (HSDPA) network this type of service differentiation is referred to as a Relative Bitrate (RBR) feature. As an option, the static green rate setting can be used to approximate relative service differentiation. The static profiling rates for the bearers can be determined based on the typical TN link capacity and the typical traffic mix.

However, the use of static green rates cannot provide relative service differentiation in all situations. In particular, a static profiling rate mechanism cannot handle all traffic mixes, or where there are substantial changes in the traffic mix, in per-bearer resource sharing. This means that the existing mechanisms do not provide very efficient relative service differentiation. In addition, use of a static green rate setting cannot deal with resource sharing among different Radio Access Technologies (RATs—e.g., HS & LTE). This means that the use of static green rates cannot deal with resource sharing among MBH services in a controlled way. Also, with the use of a static green rate, any available capacity (green rate) that is assigned to a bearer but is not being utilized by that bearer cannot be re-assigned for use by other bearers.

### SUMMARY

A first aspect provides a method of transporting data packets over a telecommunications transport network. The data packets are carried by a plurality of bearers, the bearers each carrying data packets that relate to different ones of a plurality of services. In the method, a multi-level bandwidth profiling scheme is applied to the data packets of each bearer. A series of information rates are assigned to a bearer, the profiling scheme identifying and marking each data packet of the bearer based on a desired resource sharing according to the minimum information rate with which the corresponding packet is conformant. The marked data packets are forwarded through the transport network. If there is insufficient bandwidth available in the transport network to transport all data packets, data packets identified by the profiling and marked as only being conformant with a higher information rate are discarded before any data packets marked as being conformant with a lower information rate.

Embodiments provide a mechanism that extends the profiling (e.g., coloring) concept with the use of more colors, e.g., three or more colors, to provide better control of resource sharing among bearers. By using more colors, resource sharing among bearers can be controlled more precisely. Further, the higher resolution provided by the use of more colors allows handling of TN bottleneck capacity changes (e.g. using Adaptive Modulation) and resource sharing for more traffic mixes. The improved efficiency of service differentiation by using more colors in the profiling is achieved without any additional algorithmic or architectural complexity, and without requiring any network feedback from a remote device. The mechanism only requires the profiler and the TN be color aware to support use of more colors.

Embodiments include determining the different bearer coloring rates based on different bandwidth requirement levels for each service. As an example, for a premium subscriber the profiling levels can be set to 10 Mbps, 5 Mbps and 1 Mbps respectively, representing a target bitrate for a low system load, medium system load, and high system load scenarios.

### BRIEF DESCRIPTION OF THE DRAWINGS

FIG. 1 shows a schematic of the transport of data packets of bearers over a Transport Network (TN).

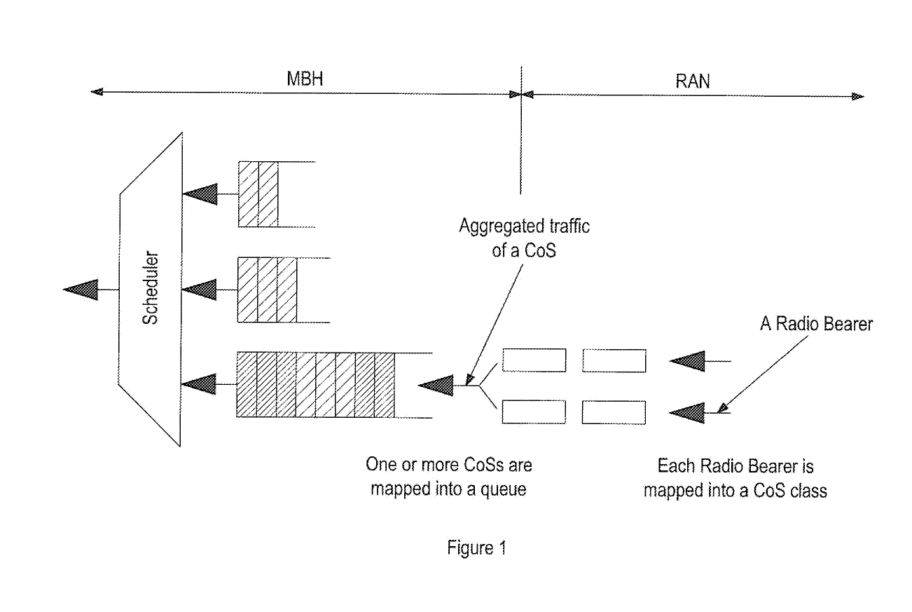

FIG. 2 shows a schematic of a TN employing a known per-bearer bandwidth profiling mechanism.

FIG. 3 shows a schematic of a TN employing a multi-level per-bearer bandwidth profiling mechanism according to one exemplary embodiment.

FIG. 4 shows the results of simulations of a TN employing a multi-level per-bearer bandwidth profiling mechanism.

FIG. 5 shows a flow diagram for an exemplary method of multi-level per-bearer bandwidth profiling.

FIG. 6 shows a block diagram of the functional components in a network entity configured for use with a multi-level per-bearer bandwidth profiling mechanism.

### DETAILED DESCRIPTION

The embodiments described herein apply per-bearer bandwidth profiling to control resource sharing among bearers carrying different services. The embodiments employ a ‘color’ profiling scheme of the type described above.

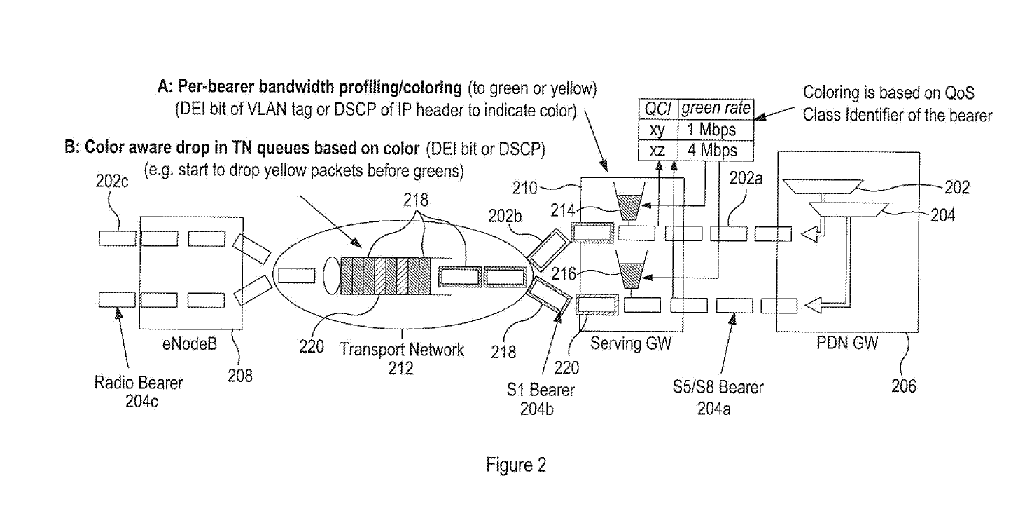

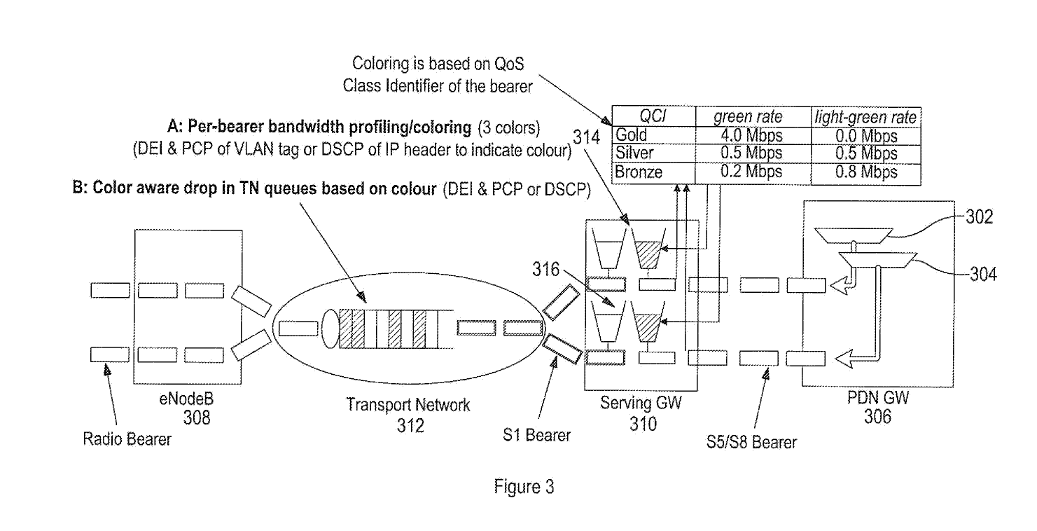

FIG. 3 shows a schematic illustration of a TN employing bandwidth profiling for each of two bearers. The example in FIG. 3 is shown for an LTE system with two bearers 302, 304, each carrying data packets between a PDN-GW 306 and an eNodeB 308 via a S-GW 310 and through a TN 312. As in FIG. 2, each bearer is assigned a bandwidth profiler—profiler 314 for bearer 302 and profiler 316 for bearer 304. Each of the bearers has an assigned QCI, which will be discussed further below, and which is used to determine a Committed Information rate (CIR) (or green rate) and one or more an Excess Information Rates (EIRs) (or ‘light green’ rate(s)) for each bearer.

The profilers 314, 316, each comprise multi-level profilers. In the example shown, three colors are used in each profiler—green, light green, and yellow. The profilers 314, 316 mark the packets of each bearer 302, 304 that conform with the green rate at the bearer's profiler 314, 316 as conformant packets 318 (e.g., assigned ‘green’). The profilers 314, 316 mark the packets of each bearer that do not conform with the green rate (CIR), but do conform with the light green rate (EIR) as light green packets 319. The profilers 314, 316 mark the packets that do not conform with the green or light green rates as non-conformant or yellow packets 320. This example is of a two-rate, three-color profiler, which means that all data packets that are not assigned ‘green’ or ‘light green’ by the profilers 314, 316 are assigned ‘yellow’. It will be appreciated that the principles described herein may readily be extended to include more than three colors, in which case an additional EIR needs to be specified (or determined) for each additional color and for each bearer.

The TN 312 bottleneck active queue management can then use the color information marked in the data packets when choosing which packets to drop when there is insufficient bandwidth (congestion). The first packets to be dropped will be the ‘yellow’ packets 320. If there are no yellow packets (either because these have already been dropped, or because no packets have been colored yellow by the profilers 314, 316), then the next packets to be dropped will be the light green packets.

The rates, e.g., the CIR and the one or more EIRs, of the colors may be determined based on the desired resource sharing among bearers. The use of more colors allows better optimization of resource sharing at more bottleneck capacity levels and/or traffic load mixes. Bearers having different characteristics (e.g., different bitrate requirements) have different QCI values. This bearer classification is done at the bearer setup. The profiling rates of a bearer are then determined based on the QCI value. Thus, the QCI of the bearer is an input to the mechanism. For example, as shown in FIG. 3, the QCI values may reflect services prioritized by operators assigning each user a gold, silver, or bronze priority level. The green rate (CIR) and light green rate (EIR) of each QCI category of user is indicated in the figure. Note that the light green rates shown in FIG. 3 are the amounts in Mbps above the green rate setting—thus the Gold user's light green rate is show as 0.0 MBps, meaning that the actual total EIR is 4.0 Mbps, or the same as the green rate, while the silver user's light green rate is 1 Mbps.

The set rates may be load/capacity dependent profiling rates set for each bearer. This provides better open loop control of the per bearer resource sharing. For example, as shown in FIG. 3, the gold user (using a gold bearer) is guaranteed 4 Mbps, but silver and bronze users are only guaranteed 1 Mbps in a low load condition, and only 0.5 Mbps for the silver users and 0.2 Mbps for the bronze users at medium load. In this way we protect the gold user, and the bronze user is down-prioritized compared to the silver user in higher load. For example, the light green rate reflects the low load condition with both silver and bronze users having a target bandwidth of 1 Mbps, but the green rate reflects the higher load condition, where the silver user is allocated 0.5 Mbps while the bronze user is only allocated 0.2 Mbps for such higher load conditions.

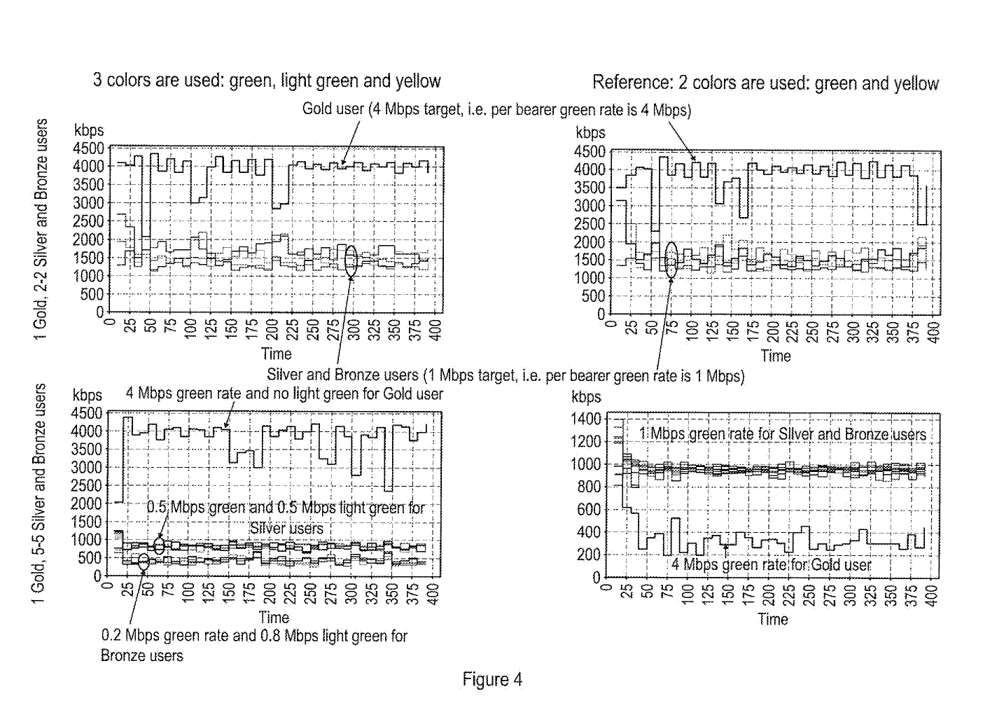

FIG. 4 shows simulation results using the rates of the example above for gold, silver and bronze users. The graphs on the left hand side show the effect of using a three-level (e.g., three-color) profiler. For comparison, the graphs on the right show normal profiling with two colors, in which the green rates of the silver and bronze users were the same as the light green rates shown in FIG. 3. The top graphs show results when there is one gold user, two silver users, and two bronze users. The TN bottleneck capacity is 10 Mbps, and so in this case there is no congestion and the two graphs (top left and top right) show little change, with the gold user being able to use the full 4 Mbps and the silver and bronze users each able to use their 1 Mbps. The bottom two graphs show the effect of the different profiling mechanisms when there is congestion due to there being one gold user, five silver users, and five bronze users. As can be seen, the effect of the three-color profiling is that the gold user continues to be able to use the full 4 Mbps most of the time, while the silver and bronze users are restricted to much lower bandwidths by their low green rates. However, in the two-color mechanism, the large number of silver and bronze users having 1 Mbps green rates have a severe impact on the gold user.

In the reference case (with two colors) the profiling rate is optimized for a traffic mix of one gold user, two silver users, and one bronze user. However, with the additional/third color the profiling can be optimized for two working points or traffic mixes. One working point or traffic mix is the same as above (one gold, two silver, two bronze), and the other working point or traffic mix is for a higher load (one gold, five silver, five bronze). FIG. 4 illustrates that the multi-level profiling provides better resource sharing for both traffic mixes.

An explanation of this effect is that the bearer level profiling works optimally when the sum of the green rates of the ongoing bearers is about equal to, or a little less than, the bottleneck capacity. When predefined profiling rates are used for the bearers, then the sum of the green rates depends on the actual traffic mix. In the above example for the one-two-two traffic mix, the sum of the green rates in the two-color profiler and the sum of the EIRs (the total green+light green rates) in the three-color profiler was 8 Mbps. In this case there was no need to drop any green packets because the bottleneck capacity was 10 Mbps. But for the other traffic mix, in the two-color profiler the total rate was 14 Mbps, therefore almost all packets were colored green (and almost none were colored yellow). Therefore, green packets were dropped and the advantage of per bearer color profiling was lost. However, by using more color levels, packet differentiation can be applied for more capacity/load situations. In the three-color profiler, the sum of the green rates was only 7.5 Mbps. In the high load traffic mix there was no dropping of green packets, but some dropping of light green packets. In this way, for example, the gold user was protected because it had only green packets.

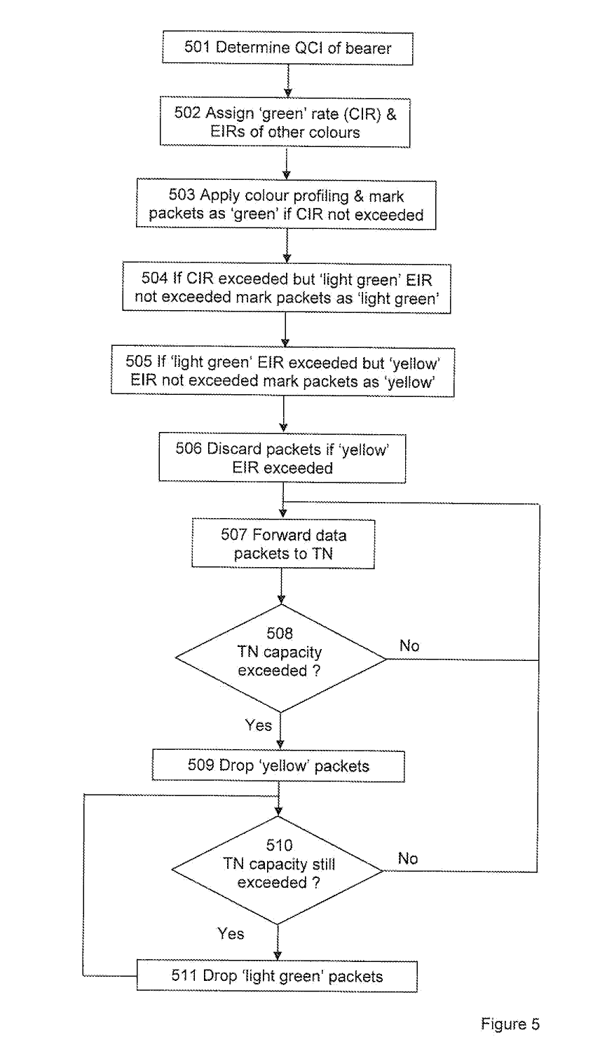

FIG. 5 shows a flow diagram illustrating the principal steps in a method of implementing the multi-level profiling mechanisms described above. The diagram illustrates the use of three colors, although it will be appreciated that it can easily be extended to include more colors. An initial determination is made of the type of a bearer (QCI value) (block 501), and the green rate (CIR) and the EIR(s) applicable to the other colors used at the profiler (e.g., light green and yellow) are assigned to the bearer (block 502). The profiler 314, 316 applies color profiling to the data packets of the bearer, and marks the data packets as green if the CIR is not exceeded (block 503). If the CIR is exceeded, but not the light green EIR, then data packets are colored ‘light green’ (block 504). If the light green EIR is exceeded, but not the yellow EIR, then data packets are colored ‘yellow’ (block 505). If the yellow EIR is exceeded, then the data packets are discarded (block 506).

The data packets are forwarded to the TN 312 (block 507). Before being sent over the TN 312, it is determined if there is congestion in the TN 312, e.g., if the TN capacity is exceeded (block 508). If not, then the method loops back to block 507. If there is congestion, then data packets marked with the highest information rate, e.g., ‘yellow’ data packets, are dropped (block 509). A further determination is made as to whether the capacity of the TN 312 is still being exceeded (block 510). If not, then the method returns to block 507. If there is still congestion (capacity of TN 312 is still being exceeded), then data packets of the color corresponding to the next highest information rate, e.g., light green in this three-color example, are dropped (block 511), and the method loops back to block 510. Only if after looping back to block 510 after all colors of data packets other than green have been dropped will the method proceed to drop green packets at block 509.

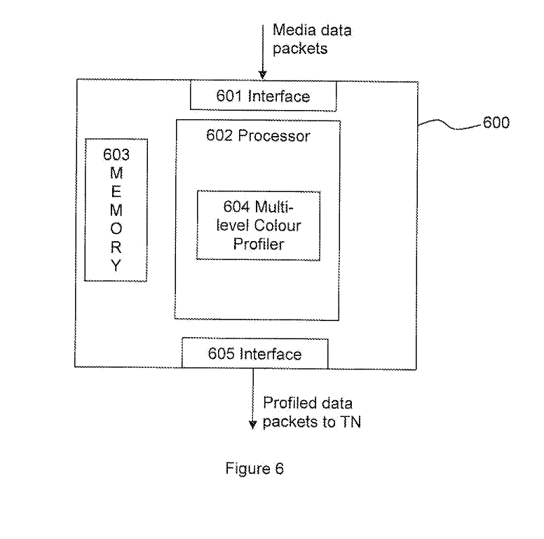

FIG. 6 shows a block diagram of the principal functional components of a RAN entity 600 applying the multi-level profiling mechanisms described herein. The entity includes an interface 601 through which media data packets of one or more bearers arrive, which are destined to be transported over a TN 312, and another interface 605 through which media data packets are forwarded on to the TN 312. The network entity 600 also includes a processor 602 and a memory 603 storing data and programming instructions for the processor 602. Processor 602 includes a multi-level bandwidth profiler 604 that applies color profiling to the data packets of each of the bearers. Profiler 604 may comprise a profiler for each bearer, e.g., profiler 314 and profiler 316. A series of information rates are assigned to each bearer and stored in memory 603. The profiler 604 identifies and marks each data packet of the bearer according to the minimum information rate with which the packet is conformant, or if the data packet is not conformant with any of the information rates. The marked data packets are forwarded via interface 605 for transport through the transport network 312.

The mechanisms and embodiments described above provide a more efficient per-bearer level service differentiation without requiring additional algorithmic and/or architectural complexity at the TN (MBH edge). The mechanisms also allow for control of resource sharing to cover several different traffic mixes and/or in several capacity levels in the TN. Using more colors improves the operation of the TN bottleneck and provides better control of resource sharing among bearers. With more colors resource sharing can be controlled more precisely, for example by adjusting for bottleneck capacity changes and in providing controlled resource sharing for more traffic mixes.

1. A method of transporting data packets over a telecommunications transport network, wherein the data packets are carried by a plurality of bearers, the bearers each carrying data packets that relate to different ones of a plurality of services, the method comprising:
applying a multi-level bandwidth profiling scheme to the data packets of each bearer, wherein a series of information rates are assigned to a bearer, the profiling scheme identifying and marking each data packet of the bearer based on a desired resource sharing scheme according to the minimum information rate with which the packet is conformant; and
forwarding the marked data packets for transport through the transport network, wherein if there is insufficient bandwidth available in the transport network to transport all data packets, data packets identified by the profiling and marked as only being conformant with a higher information rate are discarded before any data packets marked as being conformant with a lower information rate.

2. The method of claim 1 wherein the series of information rates assigned to a bearer include a committed information rate (CIR) and one or more progressively higher excess information rates (EIRs).

3. The method of claim 2, wherein the CIR and each of the one or more EIRs of the bearer are determined based on a QoS class identifier (QCI) of the bearer.

4. The method of claim 2, wherein applying the multi-level bandwidth profiling scheme includes assigning and marking the data packets of a bearer that are conformant with the CIR as green data packets, and assigning and marking other data packets using other colors corresponding to the EIR with which the packet is conformant.

5. The method of claim 4, wherein applying the multi-level bandwidth profiling scheme further comprises adding an indication of the packet color to a data field in the packet.

6. The method of claim 5 wherein the indication of the packet color comprises at least one of a Drop Eligibility (Del) bit and a Differentiated Services Control Point (DSCP) field in an IP header of the packet.

7. The method of claim 1 wherein the information rates are assigned to each of the bearers based on the desired resource sharing scheme among all of the bearers.

8. The method of claim 7, wherein the desired resource sharing scheme includes assigning a priority level to each of the bearers, and wherein the information rates for each bearer are determined based on the priority level of the bearer.

9. The method of claim 8, wherein each of the series of information rates assigned to a bearer having the highest priority level is the same information rate.

10. The method of claim 1 wherein the sum of the minimum information rates assigned to all of the bearers is approximately equal to the capacity of the transport network.

11. A network entity of a telecommunications network that provides data packets for transport through a transport network, wherein the data packets are carried by a plurality of bearers, the bearers each carrying data packets that relate to different ones of a plurality of services, the network entity comprising a multi-level bandwidth profiler configured to:
applying a bandwidth profiling scheme to the data packets of each of the bearers, wherein a series of information rates are assigned to a bearer, the profiling scheme identifying and marking each data packet of the bearer based on a desired resource sharing scheme according to the minimum information rate with which the packet is conformant; and
forward the marked data packets for transport through the transport network.

12. The network entity of claim 11, wherein the network entity comprises a Serving Gateway (S-GW) or a Packet Data Network Gateway (PDN-GW) in a Long Term Evolution (LTE) network.

13. The network entity of claim 11, wherein the network entity comprises a Radio Network Controller (RNC) or a Gateway GPRS Support Node (GGSN) in a High-Speed Downlink Packet Access (HSDPA) network.
